(19) United States
(12) Patent Application Publication
(10) Pub. No.: US 2012/0058652 A1
(43) Pub. Date: Mar. 8, 2012

(54) CONNECTOR HAVING IMPROVED RELEASING MECHANISM

(75) Inventors: CHIEN-CHIUNG WANG, New Taipei (TW); QING-MAN ZHU, Kunshan (CN); XUE-LIANG ZHANG, Kunshan (CN)

(73) Assignee: HON HAI PRECISION INDUSTRY CO., LTD., New Taipei (TW)

(21) Appl. No.: 13/226,706

(22) Filed: Sep. 7, 2011

(30) Foreign Application Priority Data
Sep. 8, 2010 (CN) 201010275688.6

(51) Int. Cl. H01R 13/627

(52) U.S. Cl. 439/76.1

(57) ABSTRACT

A connector (100) adapted for inserting into a cage (400) having a latching hole (401), the connector includes a cover (20) stamped from a metal sheet and a PCB (10) mounted in the cover for transmitting high frequency signal transmission. The cover has an integral arm (210). The arm has an outward tab (211) engaged with the latching hole for latching the connector with the cage. The arm is operable to move inwardly to disengage the tab from the latching hole for unlatching the connector with the cage.

### BACKGROUND OF THE INVENTION

1. Field of the Invention

The present invention relates to a connector, and more particularly to a SFP (Small Form-Factor Plug) connector having a latching or releasing mechanism.

2. Description of Related Art

Various types of latching or de-latching mechanisms are known, including pull-to-open type, push-to-open type, sliding-action type, and pivoting-action type. For example, U.S. Pat. No. 7,325,975, issued to Yamada on Feb. 5, 2008, discloses a connector for mating with a receptacle or cage which has a latching tab defining a latching hole. The connector comprises a housing having a latching protrusion for engaging with the latching hole, and a releasing mechanism. The releasing mechanism includes a shaft assembled to the housing. The releasing mechanism further includes a lever mounted on the shaft. The lever can be rotated around the shaft. The lever further has an actuator at a rear portion thereof and a tongue attaching to the latching tab at a front portion thereof. The tongue can be moved upwardly by inwardly or downwardly pressing the actuator. The lever actuates the latching tab upwardly from a latched position to a released position. The releasing mechanism further includes a spring for returning the actuator to the latched position. The shaft, the spring, the latching protrusion, and the lever constitute the releasing mechanism having a complicated configuration.

Hence, a connector having an improved releasing mechanism is desired.

### SUMMARY OF THE INVENTION

Accordingly, an object of the present invention is to provide a connector. The connector can be engaged with a cage defining a latching hole. The connector includes a cover having a top wall including an elastic arm. The cover has a top wall connecting an elastic arm. The elastic arm has an operator being movable perpendicularly to the top wall, and a tab extending upwardly from the elastic arm engaging with the latching hole at a latched position for latching the connector with the cage. When the operator is depressed downwardly, the tab moves downwardly together with the operator from the latched position to a released position for releasing the connector from the cage. The elastic arm is stamped from a metal sheet and has a simple structure.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing a connector assembly including a cage and a connector of the present invention;

FIG. 2 is a perspective view showing the connector separated from the cage as shown in FIG. 1;

FIG. 3 is a partially exploded perspective view showing the connector as shown in FIG. 2;

FIG. 4 is an exploded perspective view showing the connector as shown in FIG. 2;

FIG. 5 is another exploded perspective view showing the connector as shown in FIG. 2 taken from another aspect;

FIG. 6 is an enlarged view showing the elastic arm marked by a circle in FIG. 3; and

FIG. 7 is a cross-sectional view of the connector and a cage in a latched position, taken along line 7-7 of FIG. 1.

### DETAILED DESCRIPTION OF THE PREFERRED EMBODIMENT

Reference will now be made in detail to the preferred embodiment of the present invention.

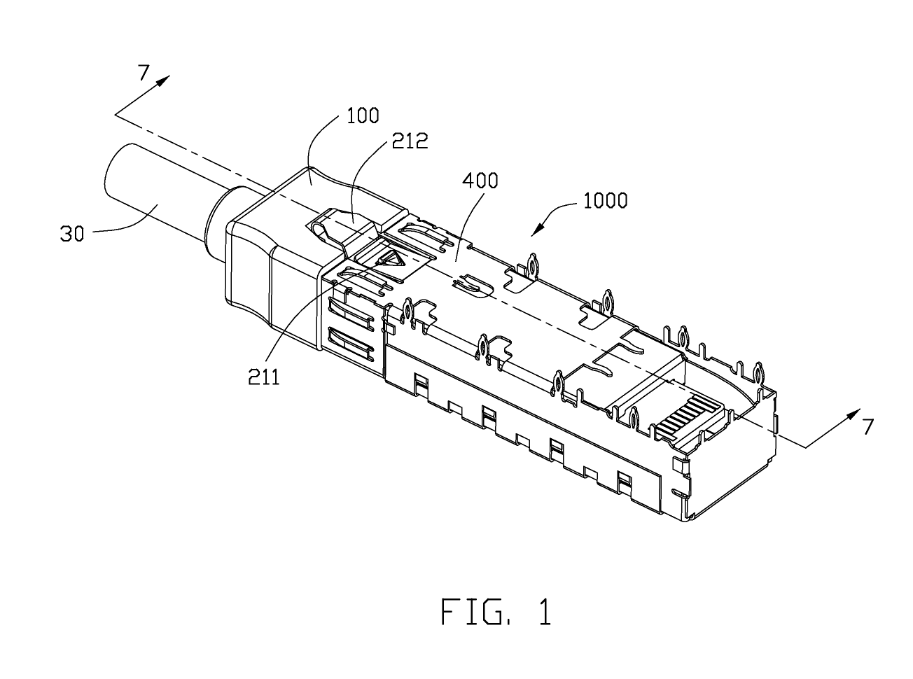

Referring to FIG. 1, a connector assembly 1000 includes a cage 400 and an electrical connector 100 inserted in the cage 400. The connector 100 has a rear portion connecting with a cable 30 and a front portion mating with a receptacle connector (not shown).

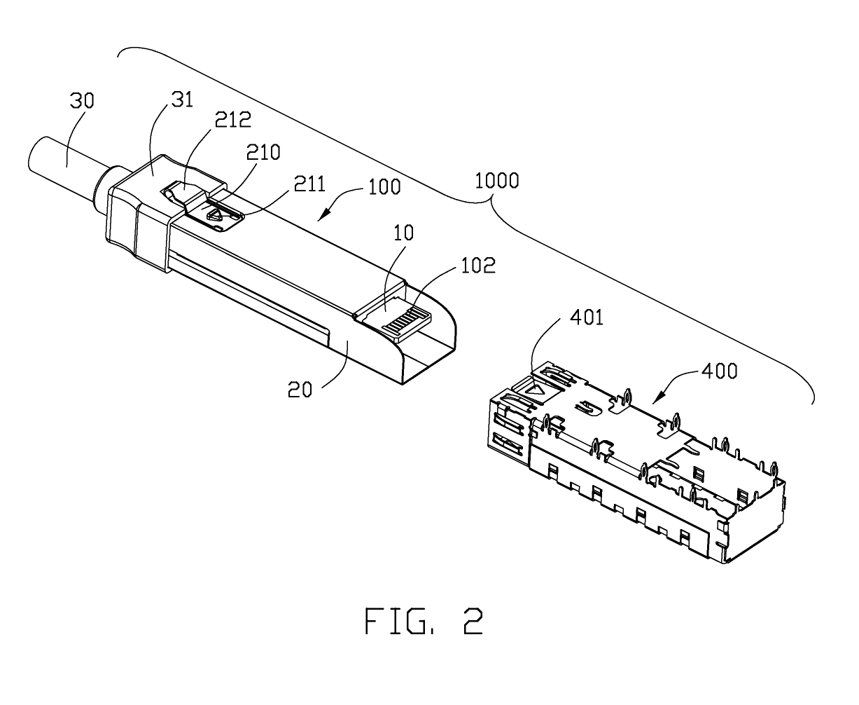

Referring to FIG. 2, the connector 100 includes an internal printed circuit board (PCB) 10, a cover 20 stamped from a metal sheet, and a dielectric cover 31 attached to the rear portion of the cover 20. The PCB 10 has a front mating portion 102 protruding out of the cover 20 for mating with the receptacle connector, and a rear soldering portion for soldering the cable 30.

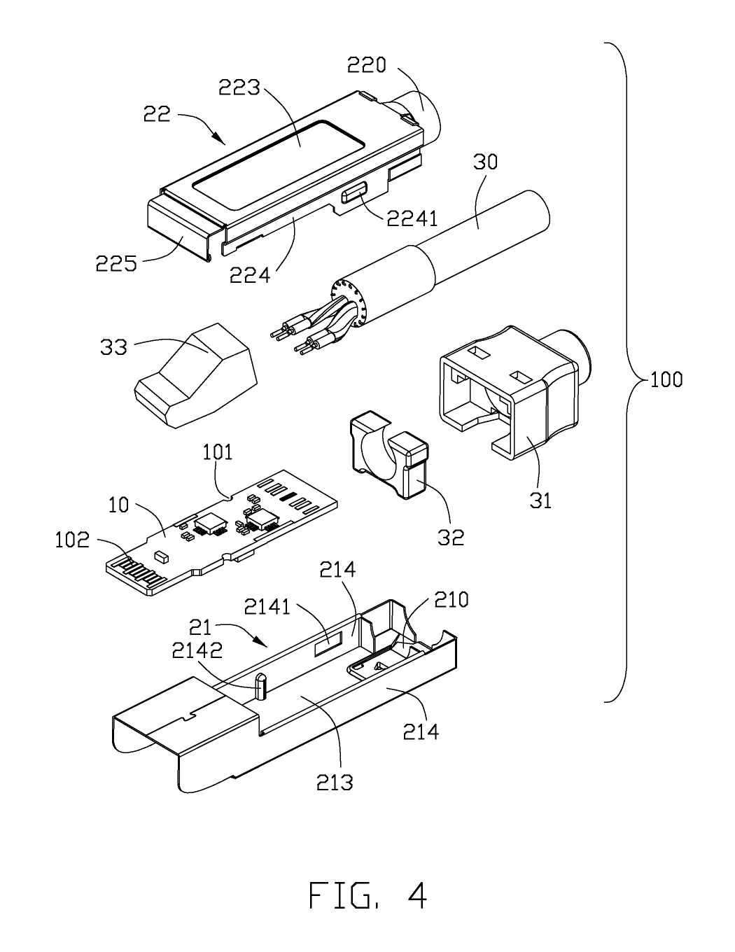

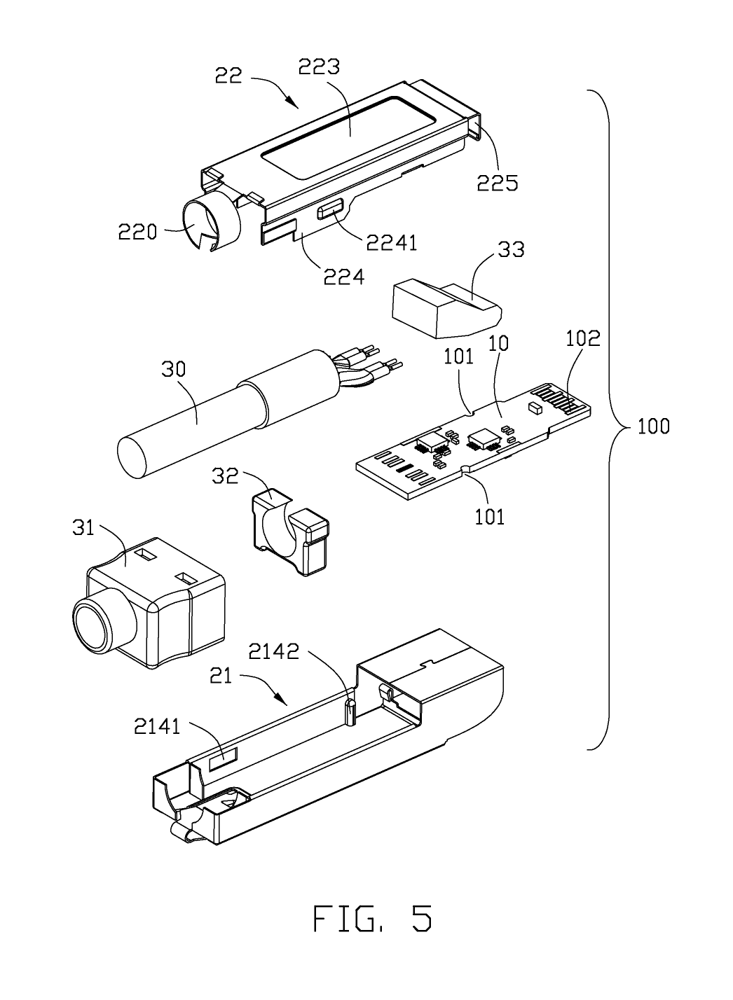

Referring to FIGS. 2 to 5, the connector 100 further includes a molded block 33 mounted to the rear portion of the PCB 10. The molded block 33 encloses the end of the cable 30 to protect a soldering joint area between the cable 30 and the PCB 10. The molded block 33 may alternatively be supported by the cover 20 to securely fix the PCB. The connector 100 optionally includes a conductive foam 32 filled in the back of the dielectric cover 31 to reduce the crosstalk around the connector.

The cover 20 includes a first cover portion 21 and a second cover portion 22 cooperating with each other. The second cover portion 22 further includes a ring 220 extending from the rear portion of the second cover portion 22. The ring 220 clips the cable 30 for improving the retention force between the cable 30 and the connector 100. The ring 220 also could be defined on the first cover portion 21. The dielectric cover 31 attaches to the rear portion of the cover 20 and wraps the ring 220.

The first cover portion 21 includes a top wall 213 having two opposite side edges and a front edge. The first cover portion 21 further includes two peripheral walls 214 extending vertically from the side edges of the top wall 213. The peripheral walls 214 are generally parallel with each other. The first cover portion 21 further has a front upper wall 215 vertically extending from the front edge of the top wall 213. The front upper wall 215 defines an opening 2150 for engaging the PCB 10 downwardly along a first direction (up-to-bottom direction) to prevent the PCB 10 from moving along a second direction (right-to-left direction). The first cover portion 21 has at least one groove 2141 formed at the rear portion of the peripheral wall 214. The first cover portion 21 has a rib 2142 formed at the inner side of the peripheral wall 214. The PCB 10 has a notch 101 defined at a side edge. The rib 2142 is inserted into the notch 101 along a first direction to prevent the PCB 10 from moving along a third direction (front-to-back direction). The first, second and third directions are orthogonal to one another.

The second cover portion 22 includes a bottom wall 223 having two opposite side edges and a front edge. The second cover portion 22 includes two side walls 224 extending vertically from the side edges of the bottom wall 223. The second cover portion 22 has a front lower wall 225 extending vertically from the front edge of the bottom wall 223. Each of the side walls 224 has at least one protrusion 2242 extending inwardly from the side wall 224 for supporting the PCB 10 upwardly.

The front upper wall 215 and the front lower wall 225 shield most of the region around the front portion of the PCB 10 to reduce crosstalk. Each of the two side walls 224 has at least one projection 2241 extending outwardly at the rear portion of the second cover portion 22. The first cover portion 21 locks with the second cover portion 22 at the rear portion by engaging the projection 2241 with the groove 2141. The first cover portion 21 and the second cover portion 22 cab be coupled together by other suitable means well known in this art.

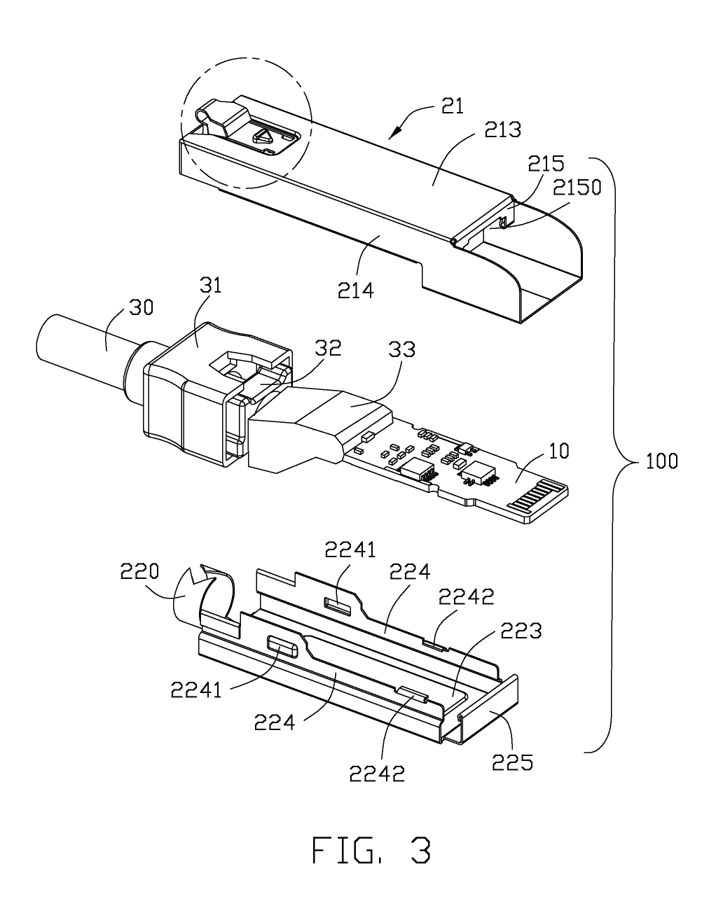

In conjunction with FIGS. 3 to 5, the first cover portion 21 is fastened to the second cover portion 22 at the front portion and locked with the second cover portion 22 at the rear portion. The protrusions 2242 and the opening 2150 holding the PCB 10 from both an up-to-bottom direction and a right-to-left direction. The rib 2142 is locked within the notch 101 of the PCB 10 for preventing the PCB 10 from moving along the front-to-back direction. Consequently, the PCB 10 could be assembled securely in the cover 20 when the first cover portion 21 is assembled to the second cover portion 20. The connector 100 has an improved structure to fix the PCB 10 easily.

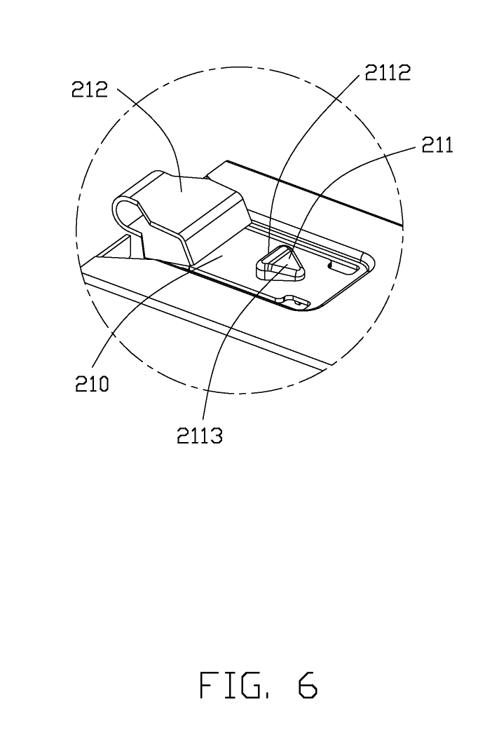

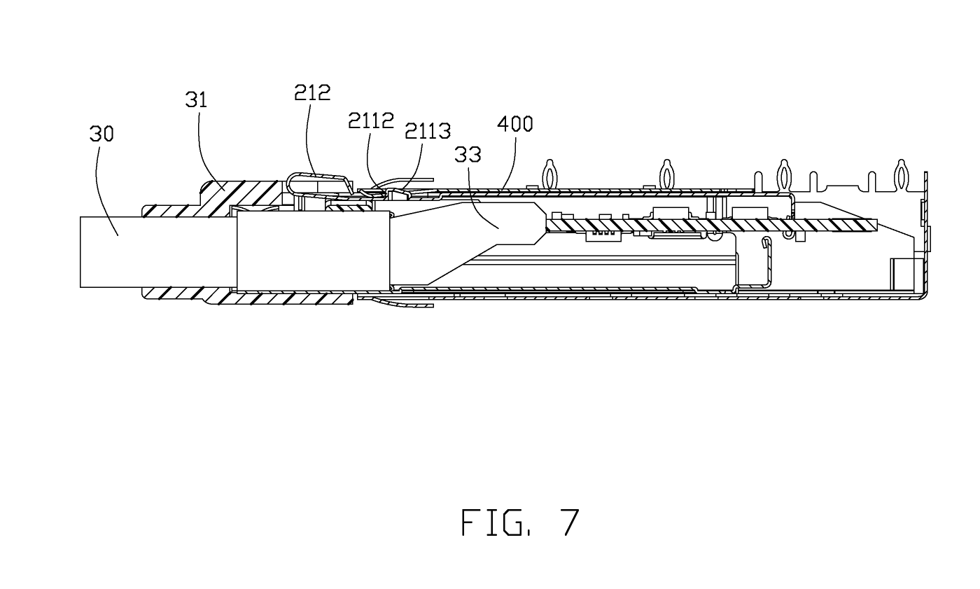

Referring to FIGS. 2, 6, and 7, the first cover portion 21 further has two slits 2101 cut from the top wall 213 by stamping. The top wall 213 therefore forms an integral flexible or elastic arm 210 between the slits 2101. The elastic arm 210 extends backwardly horizontally from the top wall 213 in a cantilever configuration. The elastic arm 210 comprises a front portion connecting to the main part of the top wall 213 and a rear free end portion 2102 against the front portion thereof. The rear free end portion 2102 can move up and down relative to the front portion of the elastic arm 210 by rotating around the front portion. The movement of the rear free end portion 2102 imparts to the elastic arm 210 a resilient returning force. The elastic arm 210 has a tab 211 extending upwardly between the front portion and the rear free end portion 2102, and an operator 212 upward and frontward extending from the end of the rear free end portion 2102. The operator 212 is inturned and adapted for convenient operation by a finger. The elastic arm 210 also could be formed on the second cover portion 22, depending on specific applications. The operator 212 is designed to essentially move inwardly or downwardly, i.e., along the first direction, by a simple pressing action. The cage 400 has a latching hole 401 for receiving the tab 211.

The tab 211 includes a ramp surface 2113 inclining forwardly and downwardly to lead the latching hole 401 mating with the tab 211 when the connector 100 is inserted into the cage 400. The tab 211 is received in the latching hole 401 at a latched position for locking the connector 100 in the cage 400. The tab 211 has a vertically extending resisting surface 2112 to resist against the latching hole 401.

When the operator 212 is depressed downwardly, the tab 211 moves together with the operator 212 downwardly from the latched position to a released position for releasing the connector 100 from the cage 400. The tab 211 returns from the released position back to the latched position via the resilient force provided by the elastic arm 210 once the tab 211 is out of the latching hole 401.

It is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector adapted for inserting into a cage having a latching hole, comprising:
a printed circuit board (PCB) having a front mating portion for mating with a receptacle connector in the cage and a rear soldering portion for soldering a cable; and
a cover stamped from a metal sheet for mounting and shielding the PCB, the cover having an integral arm, the arm having an outward tab for engaging with the latching hole for latching the connector with the cage, the arm being operable to move inwardly to disengage the tab from the latching hole for unlatching the connector from the cage.

2. The connector as claimed in claim 1, wherein the cover comprises a top wall, and said arm has a front portion connecting to the top wall and a rear free end portion, the rear free end portion being pressible to move relative to the front portion.

3. The connector as claimed in claim 2, wherein said arm has an operator extending upward and frontward from the free end portion.

4. The connector as claimed in claim 2, wherein said tab is positioned between the front portion and the free end portion, the tab being moveable together with the free end portion inwardly for disengaging the tab from the latching hole.

5. The connector as claimed in claim 1, wherein said tab includes a ramp surface inclining forwardly and downwardly for leading the tab into the latching hole.

6. The connector as claimed in claim 1, wherein said tab has a vertical resisting surface.

7. The connector as claimed in claim 1, wherein said cover includes a first cover portion and a second cover portion coupling with each other.

8. The connector as claimed in claim 7, wherein said PCB is engaged between the first cover portion and the second cover portion.

9. An electrical connector assembly comprising:
a metallic cage including two opposite primary walls in a vertical direction and two opposite side walls in a transverse direction perpendicular to said vertical direction to commonly define an elongated rectangular receiving space having an opening in a front end region;
a complementary receptacle connector located around a rear end region of the receiving space opposite to said front end region in a front-to-back direction perpendicular to both said vertical direction and said transverse direction;
one of said opposite primary walls defining around the front end region thereof a locking tang with a locking hole therein;
an electrical connector unit including two opposite primary faces and two opposite side faces to commonly define an elongated rectangular body in essentially snug compliance with the receiving space so as to be adapted to be inserted into the receiving space via the opening;
a cable linked to a rear end section of the connector unit;
a resilient arm formed on one of the two opposite primary faces and located around the rear end section with thereof a locking tab compliant with the locking hole; and
an operator associated with the resilient arm around the rear end section to actuate the resilient arm to move; wherein
when the electrical connector unit is assembled into the receiving space via the opening, the resilient arm is protectively hidden in the cage and located behind the opening to have the locking tab received in the locking hole while the operator is exposed outside of the cage and intimately located in front of the opening for good accessibility and easy operation.

10. The electrical connector assembly as claimed in claim 9, wherein the resilient arm is moveable in the vertical direction to determine whether the locking tab is received in the locking hole or not.

11. The electrical connector assembly as claimed in claim 9, wherein said electrical connector unit includes a dielectric cover to be a part of the elongated rectangular body under condition that said dielectric cover defines a recess into which said operator is received.

12. The electrical connector assembly as claimed in claim 9, wherein said connector includes a printed circuit board to be mated in the complementary receptacle connector.

13. The electrical connector assembly as claimed in claim 9, wherein the resilient arm is essentially aligned with the locking tang in said front-to-back direction.

14. The electrical connector assembly as claimed in claim 9, wherein the connector unit includes a metallic cover to be a part of the rectangular body under condition that the resilient arm is unitarily formed with the metallic cover.

15. An electrical connector assembly adapted to be received in a cage which defines a locking tang on a front end region and equipped with a receptacle connector on a rear end region opposite to the front end region in a front-to-back direction, comprising:
an elongated rectangular body having two opposite primary faces in a vertical direction perpendicular to said front-to-back direction and two opposite side faces in a transverse direction perpendicular to both said front-to-back direction and said vertical direction;
a printed circuit board disposed in the rectangular body with a mating edge exposed at a front end section of the rectangular body for mating with the receptacle connector;
a cable linked to a rear end section of the rectangular body; and
a resilient arm associated with one of the two opposite primary faces around the rear end section and adapted for being aligned with the locking tang, and equipped with a triangular locking tab thereon for engagement within the locking hole; wherein
an operator is associated with the resilient arm to actuate the resilient arm to move for disengaging the locking tab from the locking hole.

16. The electrical connector assembly as claimed in claim 15, wherein the resilient arm is moveable in only the vertical direction.

17. The electrical connector assembly as claimed in claim 15, wherein said operator is essentially immovable relative to the resilient arm in the front-to-back direction but forcing the resilient arm to move inwardly in the vertical direction.

18. The electrical connector assembly as claimed in claim 17, wherein said operator is unitarily formed with the resilient arm.

19. The electrical connector assembly as claimed in claim 15, wherein the operator is configured to be located at a specific position which is exposed outside of the cage and intimately located in front of the front end region with regard to the cage for easy accessibility and operation.

20. The electrical connector assembly as claimed in claim 15, wherein the operator is unitarily formed with a metallic cover which is a part of rectangular body.
